(19) United States
(12) Patent Application Publication
(10) Pub. No.: US 2009/0208284 A1
(43) Pub. Date: Aug. 20, 2009

(54) Clamped friction joint

(75) Inventor: Marc Funnell, Bristol (GB)

Correspondence Address: NIXON & VANDERHYE, PC, 901 NORTH GLEBE ROAD, 11TH FLOOR, ARLINGTON, VA, 22203, US

(73) Assignee: AIRBUS UK LIMITED, Bristol (GB)

(21) Appl. No.: 12/379,211

(22) Filed: Feb. 17, 2009

(30) Foreign Application Priority Data
Feb. 19, 2008 (GB) 0802938.1

(51) Int. Cl. F16B 2/18

(52) U.S. Cl. 403/374.3

(57) ABSTRACT

A clamped friction joint comprising: a composite component; and a second component which overlaps with the composite component in a region of overlap. A clamping member engages a first surface of the composite component in the region of overlap and a first surface of the second component outside the region of overlap. A fastener is arranged to pull the clamping member and the second component together so as to compress the composite component between the clamping member and the second component in the region of overlap. The clamping force applied by the clamping member and the second component facilitates load transfer across the joint without requiring any bolt hole in the composite component, or any additional bonding material.

### FIELD OF THE INVENTION

The present invention relates to a clamped friction joint—that is, a joint which connects together a pair of components using a frictional clamping force.

### BACKGROUND OF THE INVENTION

A conventional double lap bolted shear joint is shown in FIG. 1. A pair of components 1,2 are compressed between a pair of clamping members 3,4 by a pair of bolts 5,6. There is no overlap between the components 1,2.

A conventional single lap bolted shear joint is shown in FIG. 2. The components 7,8 overlap and are held together by a bolt 9.

A problem with the bolted joints of FIGS. 1 and 2 is that the bolts pass through holes in both components being joined, which causes a detrimental effect on the structure.

FIGS. 3 and 4 show equivalent bonded joints, secured with bonding material 10. A problem with the bonded joints of FIGS. 3 and 4 is that the bonding material is prone to failure.

### SUMMARY OF THE INVENTION

A first aspect of the invention provides a clamped friction joint comprising: a composite component; a second component which overlaps with the composite component in a region of overlap; a clamping member which engages a first surface of the composite component in the region of overlap and a first surface of the second component outside the region of overlap; and a fastener which is arranged to pull the clamping member and the second component together so as to compress the composite component between the clamping member and the second component in the region of overlap.

A second aspect of the invention provides a method of securing a friction joint between a composite component and a second component which overlaps with the composite component in a region of overlap; the method comprising: engaging a first surface of the composite component in the region of overlap and a first surface of the second component outside the region of overlap with a clamping member; and pulling the clamping member towards the second component so as to compress the composite component between the clamping member and the second component in the region of overlap.

The clamping force applied by the clamping member and the second component facilitates load transfer across the joint without requiring any bolt hole in the composite component, or any additional bonding material.

Various preferred aspects of the invention are set out in the dependent claims.

### BRIEF DESCRIPTION OF THE DRAWINGS

Embodiments of the invention will now be described with reference to the accompanying drawings, in which:

FIGS. 1-4 are sectional views of conventional joints;

FIG. 5 is a sectional view of a clamped friction joint according to a first embodiment of the invention;

FIG. 6 is a partially exploded isometric view of the leading edge of an aircraft wing;

FIG. 7 is a sectional view through the leading edge of the wing; and

FIGS. 8-10 are detailed sectional views showing a clamped friction joint being formed between the skin and D-nose cover.

### DETAILED DESCRIPTION OF EMBODIMENT(S)

A clamped friction joint 11 shown in FIG. 5 comprises a first composite component 12, and a second component 13 which overlaps with the composite component in a region of overlap 14. The components have inner surfaces 12a, 13a on the inner side of the joint and outer surfaces 12b, 13b on the outer side of the joint.

A clamping member 15 has a first thickness T1 where it engages the outer surface 12b of the first composite component in the region of overlap, and a second increased thickness T2 where it engages the inner surface 13a of the second composite component outside the region of overlap. The clamping member 15 may be formed from a metal, or from a similar composite material to the components 12, 12.

A bolt assembly 16 is arranged to pull the clamping member 15 and the second component 13 together so as to compress the first composite component 12 between the clamping member 15 and the second composite component 13 in the region of overlap.

The bolt assembly 16 comprises a bolt with a threaded shaft 17 which passes through a hole in the second composite component 13. The bolt has a head 18; and a washer 19 which engages the outer surface 13b of the second composite component opposite to the first surface 13a. A washer 20 engages the outer surface of the clamping member 15 and a nut 21 can be screwed onto the shaft to tighten the joint.

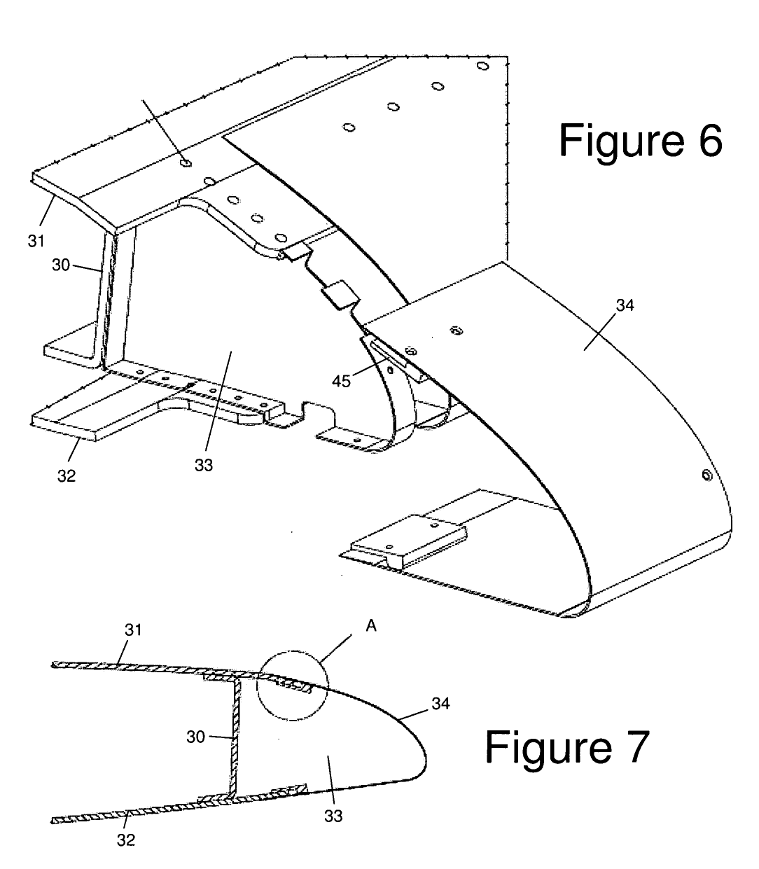

FIGS. 6 and 7 show the leading edge of an aircraft wing. The wing comprises a C-shaped front spar 30, and a pair of composite skins 31, 32 which are bolted to the upper and lower flanges of the front spar 30. A slat track rib 33 is bolted to the spar 30 and is covered by a D-nose composite leading edge cover 34.

The skins 31,32 and cover 34 are each formed from a fibre-reinforced laminar composite material such as carbon-fibre reinforced epoxy resin (CFRP).

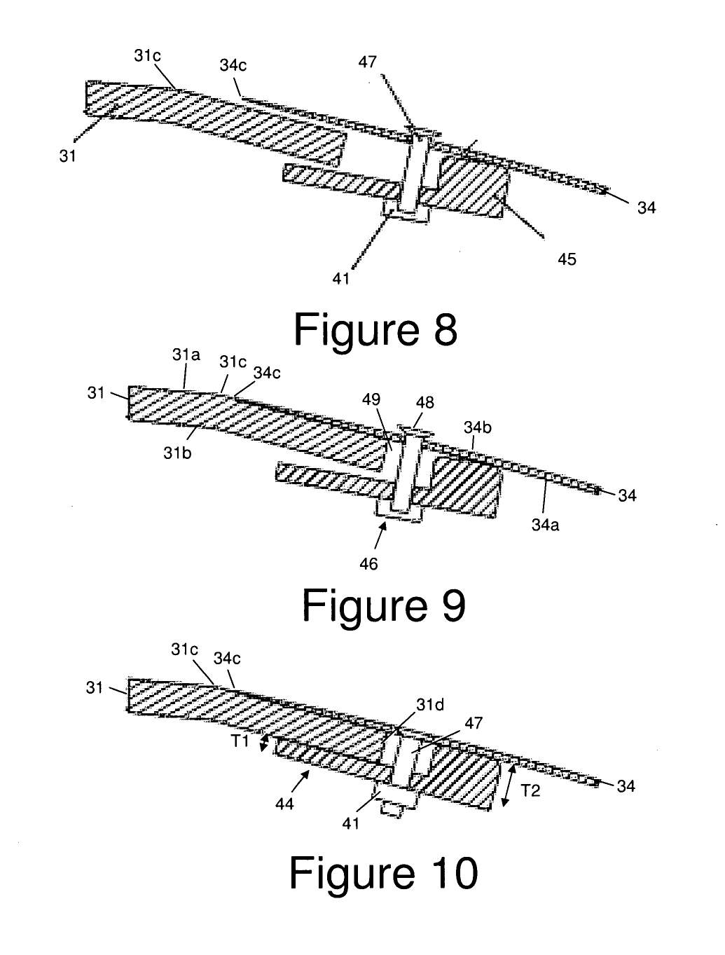

The interface between the skin 31 and cover 34 is shown in detail in FIGS. 8-10. The skin 31 and cover 34 overlap in a region of overlap 44. The skin 31 has an inner mould line (IML) surface 31b inside the wing and an outer mould line (OML) surface 31a which forms an aerodynamic surface on the outside of the wing. Similarly the cover 34 has an inner mould line (IML) surface 34a inside the wing and an outer mould line (OML) surface 34b which forms an aerodynamic surface on the outside of the wing. The OML 31a and IML 34a are on the inner side of the joint, and the IML 31b and OML 34b are on the outer side of the joint.

A clamping member 45 has a first thickness T1 where it engages the IML 31b of the skin in the region of overlap, and a second increased thickness T2 where it engages the IML 34a of the cover 34 outside the region of overlap.

A bolt assembly 46 pulls the clamping member 45 towards the cover 34 so as to compress the skin 31 between the clamping member 45 and the cover 34 in the region of overlap.

The joint is secured by the series of steps shown in FIGS. 8-10. First the cover 34 is offered up to the skin 31 as shown in FIG. 8 with the threaded shaft 47 unscrewed and the clamping member at an angle to the cover 34 as shown. Next the cover 34 is pushed into engagement with the skin 31 in the region of overlap as shown in FIG. 9 until the tapered trailing edge 34c of the cover 34 approaches a bend 31c in the skin 31, with a small space 49 between the shaft 47 and the leading edge 31d of the skin 31. Finally, the head 48 of the bolt is turned with an Allen key to screw the shaft into a self-aligning nut 41 until the head 48 tightly engages the OML 34b of the cover, thus pulling the clamping member 45 towards the cover 34 so as to clamp the skin 31 securely between the clamping member 45 and the cover 34.

The head 48 of the bolt is a tapered countersunk head 48 which is recessed within the cover 34 so as to lie flush with the OML 34b and minimise its drag penalty as shown in FIG. 10.

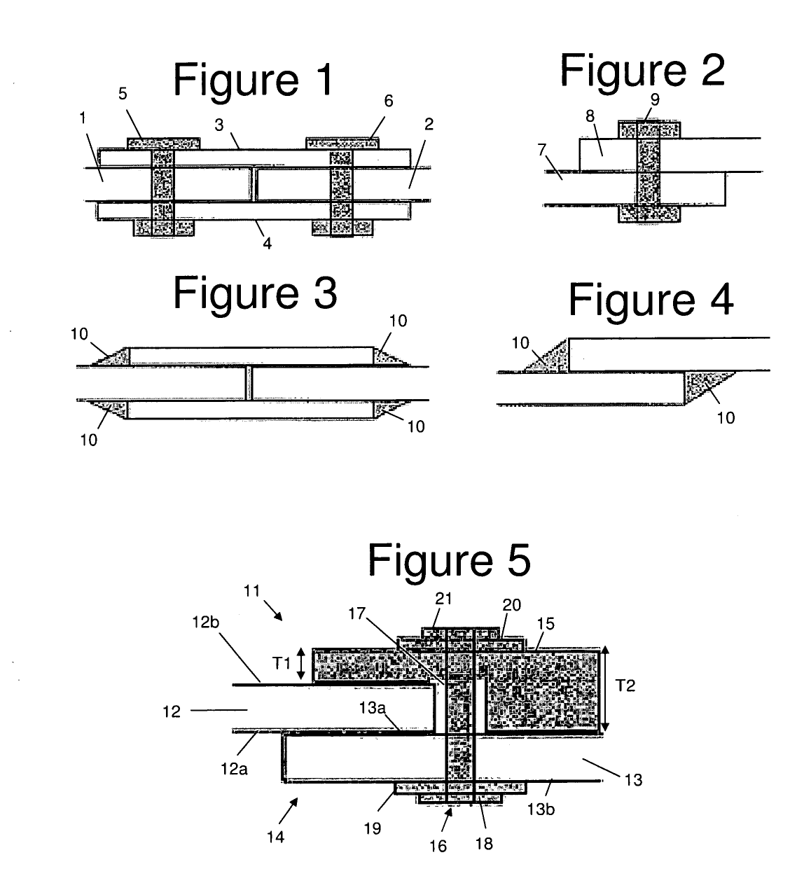

The lack of hole in the skin 31 provides a structural advantage compared with the conventional bolted joints shown in FIGS. 1 and 2. Although the bolt does pass through the cover 34, this is considered less critical since the cover 34 is not a primary structural component of the wing. Note that the cover 34, being a secondary structural component, has a much smaller thickness than the skin 31.

The friction between the surfaces as a result of pre-tension in the bolt assembly facilitate load transfer. The interference surfaces of the joint (that is, IML 34a and OML 31a) may be coated with special friction pads or similar to ensure load carrying capability under static loading and any fatigue cycling. The friction pads may be formed from an elastomer such as rubber.

The joint is light and easy to remove without damaging the skin 31.

Other applications for the joint may be envisaged, including a joint between a wing skin and a trailing edge panel; or a joint between a wing skin and a manhole cover.

Although the invention has been described above with reference to one or more preferred embodiments, it will be appreciated that various changes or modifications may be made without departing from the scope of the invention as defined in the appended claims.

1. A clamped friction joint comprising:
a composite component;
a second component which overlaps with the composite component in a region of overlap;
a clamping member which engages a first surface of the composite component in the region of overlap and a first surface of the second component outside the region of overlap; and a fastener which is arranged to pull the clamping member and the second component together so as to compress the composite component between the clamping member and the second component in the region of overlap.

2. The joint of claim 1 wherein the fastener comprises a second clamping member which engages a second surface of the second component opposite to the first surface.

3. The joint of claim 1 wherein the fastener passes through a hole in the second component.

4. The joint of claim 2 wherein the second clamping member is at least partially recessed within the second surface of the second component.

5. The joint of any claim 4 wherein the second surface of the second component comprises an aerodynamic surface of an aircraft.

6. The joint of claim 1 wherein the second component comprises a second composite component.

7. The joint of claim 1 wherein the composite component is formed from a fibre-reinforced composite material.

8. The joint of claim 1 wherein the composite component is formed from a laminar composite material.

9. The joint of claim 1 wherein the first clamping member has a first thickness where it engages the composite component and a second increased thickness where it engages the second component.

10. The joint of claim 1 further comprising a friction pad positioned between the components in the region of overlap.

11. The joint of claim 1 wherein the composite component has a greater thickness than the second component, at least in the region of overlap.

12. An aircraft comprising a joint according to claim 1.

13. The aircraft of claim 12 wherein the composite component comprises a wing skin.

14. The aircraft of claim 13 wherein the second component comprises a leading-edge cover.

15. A method of securing a friction joint between a composite component and a second component which overlaps with the composite component in a region of overlap; the method comprising: engaging a first surface of the composite component in the region of overlap and a first surface of the second component outside the region of overlap with a clamping member; and pulling the clamping member towards the second component so as to compress the composite component between the clamping member and the second component in the region of overlap.
